(19) United States
(12) Patent Application Publication
(10) Pub. No.: US 2012/0043769 A1
(43) Pub. Date: Feb. 23, 2012

(54) DOOR SECURITY DEVICE

(76) Inventor: MATILDE LLANES, Warren, AR (US)

(21) Appl. No.: 12/860,994

(22) Filed: Aug. 23, 2010

(51) Int. Cl. E05C 19/00

(52) U.S. Cl. 292/259 R

(57) ABSTRACT

A security device for bracing a door to prevent unauthorized entry comprising: a base plate, where said base plate is mounted flush in the floor near the door; a security bar, where said security bar is housed in an opening within the base plate and is capable of being moved to a lifted position; a receiving lip, where the security bar rests flush against the lip when in a closed position; and a pin, where said pin connects to one end of the security bar and provides a mechanism to pivot the security bar from the closed position to the lifted position, where the security bar is placed against the door to prevent entry through the door when in the lifted position. A plurality of screws for securing the base plate to the floor may be provided where the screws insert flush along the top surface of the plate. The security device may include an arched opening on one side of the security bar, where this opening provides enables a user to grab the security bar to place the bar in the lifted position to secure the door.

### BACKGROUND OF THE INVENTION

1. Field of Invention

The present invention relates to a door security device which provides a means to block undesired entry into a door.

2. Description of Related Art

Doors are movable barriers that provide a means for the entry and exit of a room, building or other passageway. Nearly every building has some sort of door that provides a means to enter the building and the doors come in various styles and configurations. Some doors swing on hinges, sliding doors are available, French doors or folding doors are available also rotating or revolving doors are provided for entry into a building. Most residential homes are entered through a hinge door that opens towards the interior of the home.

Most doors used on a residential building include various means to lock and secure the door for safety and to prevent unauthorized entry into the home. Locks are used in a form of latches, bolts, doorknob locks and security chains. These are various means are used to control entry into the interior of the home. Although many of these devices are effective in securing a door from unauthorized entry there continues to be a need to provide various security devices to prevent unauthorized entry into a home.

### SUMMARY OF THE INVENTION

The present invention relates to a security device for bracing a door to prevent unauthorized entry comprising: a base plate, where said base plate is mounted flush in the floor near the door; a security bar, where said security bar is housed in an opening within the base plate and is capable of being moved to a lifted position; a receiving lip, where the security bar rests flush against the lip when in a closed position; and a pin, where said pin connects to one end of the security bar and provides a means to pivot the security bar from the closed position to the lifted position, where the security bar is placed against the door to prevent entry through the door when in the lifted position. A plurality of screws for securing the base plate to the floor may be provided where the screws insert flush along the top surface of the plate. The security device may include an arched opening on one side of the security bar, where this opening provides a means to grab the security bar to place the bar in the lifted position to secure the door.

### BRIEF DESCRIPTION OF DRAWINGS

FIG. 1A depicts a side view of a door security device according to the present invention.

FIG. 1B depicts the top view of the door security device according to the present invention.

FIG. 2 depicts detailed views of components of the door security device according to the present invention.

### DETAILED DESCRIPTION

The present invention relates to a door security device that provides an additional means to secure a door to prevent unauthorized opening. The security device according to the present invention mounts flush with the floor near the door and enables the engaging of a security bar against the door to prevent the opening thereof. The security bar remains flush within the security device until lifted and mounted against a door by the user. The security device is placed at a sufficient distance away from the door so that the security bar may be lifted and placed flush against the door so that if the door is forced open and the bar acts as a blocking mechanism.

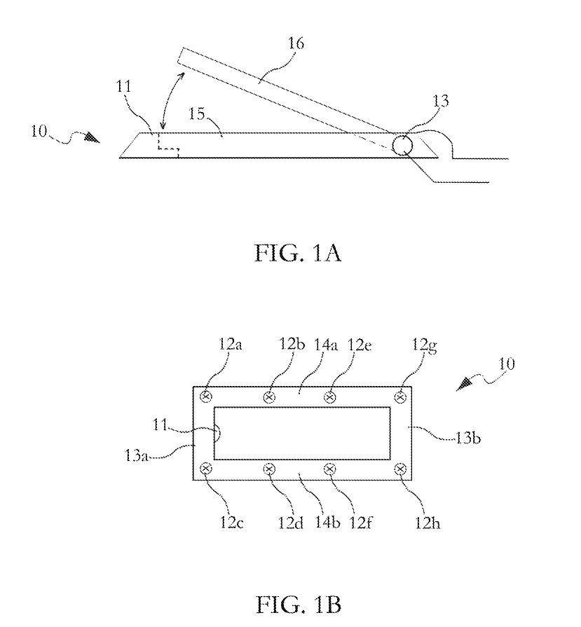

FIG. 1A depicts a side view of the security device according to the present invention. The security device 10 includes a base plate 15 that is mounted flush in the floor near a door. The base plate 15 houses a security bar 16 shown in a lifted position in FIG. 1A that fits into an opening within the base plate 15. The security bar 16 rests flush in a receiving lip 11 when in a closed position. The security bar 16 pivots about a pin 13 so that the bar 16 may be removed from the housing of the base plate 15 and placed against the door to prevent entry into the household.

Referring to FIG. 1B, a top view of the security device 10 is shown. The security device 10 is mounted into the floor through the use of a plurality of screws 12a through 12h. As shown the mounting screws are placed along a top side 14a and a bottom side 14b of the security device 10. The security device 10 is a rectangular shaped device that includes sides 13a, 13b that run perpendicular to the top side 14a and bottom side 14b. Once the device is mounted securely into the floor the security bar 16 may be lifted from the housing and placed against the door to prevent unauthorized entry into the home.

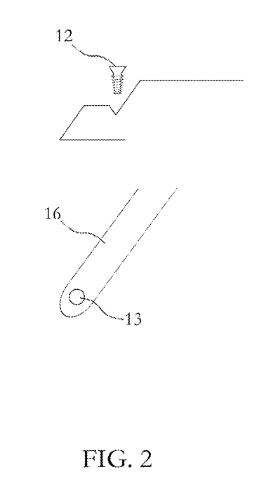

FIG. 2 depicts detailed views of a screw 12 that is inserted into one of the openings along the sides of the security device 10. As shown, the screw 12 fits flush into an opening provided in the security device. Further the security bar 16 pivots about pin 13 and provides a means to rotate the bar into position flush against the door. Also shown in the top view of FIG. 1B is a small arched opening 11 on one side of the security bar 16. This opening provides a means to grab the security bar 16 to lift it out and to place it into a position to secure the door.

The security device according to the present invention provides a means to secure the door of a residential home in order to prevent unauthorized entry thereto. Because the security device is mounted flush into the floor and the angle provided by the security bar, an individual is unable to force their way through the door. The security bar may be placed at a raised angle against the door in order to prevent the door from being forced open and acts as a blocking mechanism. Further the security device is easy to install and is flush against the floor, and therefore does not obstruct or interfere with the opening of the door when desired.

What is claimed is:

1. A security device for bracing a door to prevent unauthorized entry comprising:
a. a base plate, where said base plate is mounted flush in the floor near the door;
b. a security bar, where said security bar is housed in an opening within the base plate and is capable of being moved to a lifted position;
c. a receiving lip, where the security bar rests flush against the lip when in a closed position; and
d. a pin, where said pin connects to one end of the security bar and provides a means to pivot the security bar from the closed position to the lifted position, where the security bar is placed against the door to prevent entry through the door when in the lifted position.

2. The security device according to claim 1, further including a plurality of screws for securing the base plate to the floor.

3. The security device according to claim 2, where said screws insert flush along the top surface of the plate.

4. The security device according to claim 1, where the security bar includes a arched opening on one side of the security bar, where this opening provides a means to grab the security bar to place the bar in the lifted position to secure the door.
